(19) United States
(12) Patent Application Publication
(10) Pub. No.: US 2011/0320676 A1
(43) Pub. Date: Dec. 29, 2011

(54) SHARING DEVICE WITH MULTI CONNECTING PORTS FOR COMPUTER PERIPHRY DEVICES

(75) Inventor: Ching-Wei Cheng, Keelung (TW)

(73) Assignee: ACTION STAR ENTERPRISE CO., LTD., Sijhih (TW)

(21) Appl. No.: 12/825,403

(22) Filed: Jun. 29, 2010

(51) Int. Cl. G06F 13/00

(52) U.S. Cl. 710/316

(57) ABSTRACT

The present invention relates to a sharing device with multi connecting ports for computer periphery apparatus, capable of connecting to a plurality of hosts and computer periphery apparatus, so as to facilitate any one host of the plurality of hosts be able to communicate with and control the plurality of computer periphery apparatus without installing any high-price network sharing equipments, the sharing device comprises: a plurality of HUBs, which are parallel to each other; and a plurality of connecting ports.

### BACKGROUND OF THE INVENTION

1. Technical Field

The present invention relates to a sharing device, and more particularly, to a sharing device with multi connecting ports for computer periphery devices, in which, a plurality of HUBs is controlled to switch on/off a plurality of connecting ports through a HUB controlling program or an external main controlling unit, so that a single host may communicates with and control multi computer periphery devices at the same time.

2. Description of Related Art

With general application of networks, two different computers can share resources each other by connecting the networks, similarly, two dissimilar computers are able to jointly use a single computer periphery device through the networks, for example, to jointly employ a single printer, a single photocopier or a single scanner; However, the price of a complete network equipment is too expensive for a common family and a small company, which can not generally install the network equipment to carry out the sharing of the resources and the computer periphery devices.

In order to accomplish the object of sharing the single computer periphery device, numbers of inventers and venders do research and development hardly and propose a USB sharing device for the computer periphery device, please referring to FIG. 1, which illustrates a framework view of the USB sharing device for the computer periphery device, as shown in FIG. 1, two different hosts (AP1′ and AP2′) share a single computer periphery device 2′ via the USB sharing device 1′, the USB sharing device 1′ includes: a multiplexer 15′, a first USB controlling chip 14′, a second USB controlling chip 13′, a HUB 12′, and a USB output terminal 16′. Wherein the multiplexer 15′ is adapted to perform the switch for making the host AP1′ connect to the HUB 12′, and then the host AP1′ can further connect to the external computer periphery device 2′ through the second USB controlling chip 13′ and the USB output terminal 16′.

The above-mentioned USB sharing device 1′ is a 2-to-1 USB sharing device, furthermore, the USB sharing device 1′ is also able to be expanded as a 3-to-1 or a 4-to-1 USB sharing device, nevertheless, numbers of the hosts connecting to the USB sharing device 1′ merely can employ the single computer periphery device whatever the USB sharing device 1′ is the 3-to-1 or the 4-to-1 USB sharing device.

For nowadays human habits in aspect of using the computer periphery devices, two or more different computer periphery devices are often used at the same time, however, the USB sharing device 1′ can not meet the demand described above. Accordingly, in view of the drawbacks and shortcomings of the USB sharing device, the inventor of the present application has made great efforts to make inventive research thereon and eventually provided a sharing device with multi connecting ports for computer periphery devices according to the present invention.

### BRIEF SUMMARY OF THE INVENTION

The primary objective of the present invention is to provide a sharing device with multi connecting ports for computer periphery devices, so as to make a single host in a plurality of hosts connecting to the sharing device may control a plurality of HUBs in the sharing device to switch on/off the connecting ports by way of a HUB controlling program or a main controlling unit, and then the single host in the plurality of hosts is able to communicate with and control the computer periphery devices without installing any high-price network sharing equipments.

Accordingly, to achieve the abovementioned primary objective, the inventor provides a sharing device with multi connecting ports for computer periphery devices capable of being connected to a plurality of hosts and a plurality of computer periphery devices, so as to facilitate any one host in the plurality of hosts be able to communicate with and control the plurality of computer periphery device, the sharing device comprising:

a plurality of HUBs, which are parallel to each other; and a plurality of connecting ports, which are respectively coupled to the plurality of HUBs, wherein through a single connecting port, a single HUB can connect to a single computer periphery device. When a first HUB in said HUBs connects to a first computer periphery device, the first computer periphery device simultaneously connects to the other HUBs, when a second HUB is connected to a second computer periphery device, meanwhile, the second computer periphery device connects to the second HUB as well as the other HUBs; moreover, when a N-th HUB is connected to a N-th computer periphery device, the N-th computer periphery device connects to neither of the N-th HUB and the other HUBs.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a framework view of a USB sharing device for a computer periphery device;

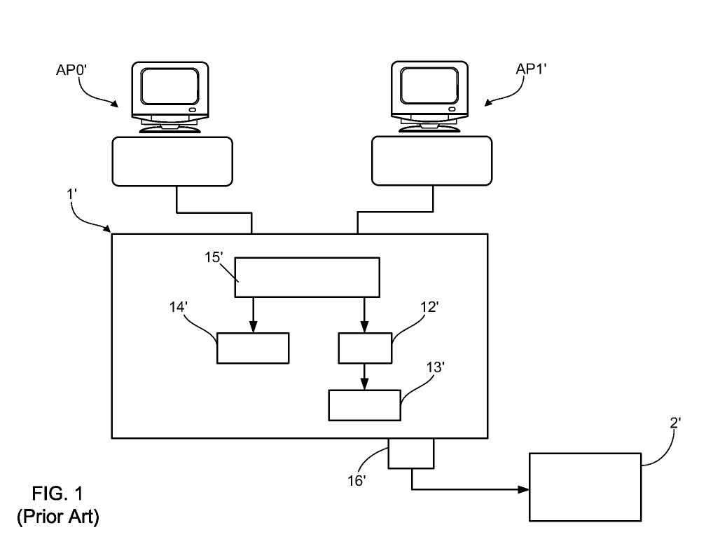

FIG. 2 is a first framework view of a sharing device with multi connecting ports for the computer periphery devices according to the present invention;

FIG. 3 is a second framework view of the sharing device with multi connecting ports for the computer periphery devices according to the present invention;

FIG. 4 is a third framework view of the sharing device with multi connecting ports for the computer periphery devices according to the present invention;

FIG. 5 is a fourth framework view of the sharing device with multi connecting ports for the computer periphery devices according to the present invention;

FIG. 6 is a fifth framework view of the sharing device with multi connecting ports for the computer periphery devices according to the present invention; and

FIG. 7 is a sixth framework view of the sharing device with multi connecting ports for the computer periphery devices according to the present invention.

### DETAILED DESCRIPTION OF THE INVENTION

To more clearly describe a sharing device with multi connecting ports for computer periphery devices according to the present invention, an embodiment of the present invention will be described in detail with reference to the attached drawings hereinafter.

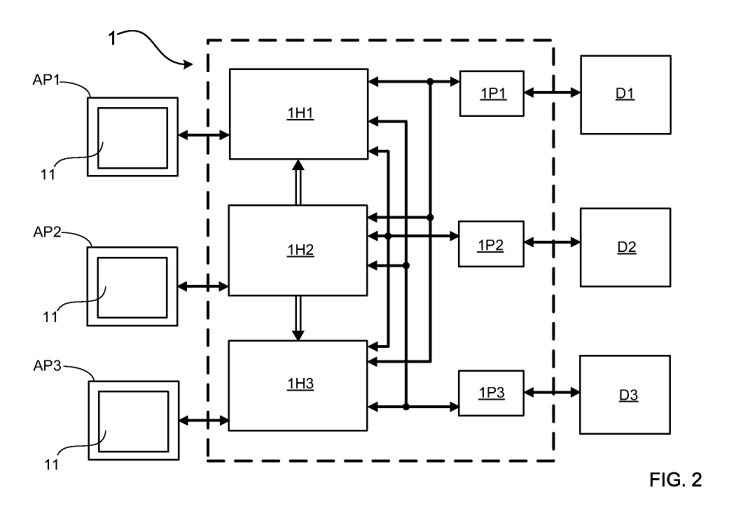

The sharing device with multi connecting ports may be connected at least two hosts and at least two computer periphery devices, so that, any one host of the at least two hosts is able to simultaneously communicate with and control the at least two computer periphery devices. Please refer to FIG. 2, which illustrates a first framework view of the sharing device with multi connecting ports for the computer periphery devices according to the present invention. The sharing device 1 with multi connecting ports for computer periphery devices capable of being connected to a first host AP1, a second host AP2 and a third host AP3, and connected to a first computer periphery device D1, a second computer periphery device D2 and a third computer periphery device D3 at the same time, so as to facilitate the first host AP1, the second host AP2 or the third host AP3 simultaneously communicate with and control the first computer periphery device D1, the second computer periphery device D2 and the third computer periphery device D3, the sharing device 1 includes: a first HUB 1H1, a first connecting port 1P1, a second HUB 1H2, a second connecting port 1P2, a third HUB 1H3, and a third connecting port 1P3.

The first connecting port 1P1 is coupled to the first HUB 1H1, through the first connecting port 1P1, the first HUB 1H1 can connect to the first computer periphery device D1. The second HUB 1H2 is parallel to the first HUB 1H1. The second connecting port 1P2 is coupled to the second HUB 1H2, the second HUB 1H2 may connect to the second computer periphery device D2 by way of the second connecting port 1P2; The third HUB 1H3 is parallel to the first HUB 1H1 and the second HUB 1H2; The third connecting port 1P3 is coupled to the third HUB 1H3, Through the third connecting port 1P3, the third HUB 1H3 can connect to the third computer periphery device D3.

The first framework of the sharing device 1 further includes a HUB controlling program 11, which can be installed in each of hosts, users may control the switching of each HUB when operating hosts by means of the HUB controlling program 11. As shown in FIG. 2, when the first HUB 1H1 is connected to the first computer periphery device D1, the first computer periphery device D1 connects to the second HUB 1 H2 and the third HUB 1H3 at the same time; When the second HUB 1H2 is connected to the second computer periphery device D2, the second computer periphery device D2 simultaneously connects to the first HUB 1H1 and the third HUB 1H3; Moreover, when the third HUB 1H3 is connected to the third computer periphery device D3, the third computer periphery device D3 also connects to the first HUB 1H1 and the second HUB 1H2.

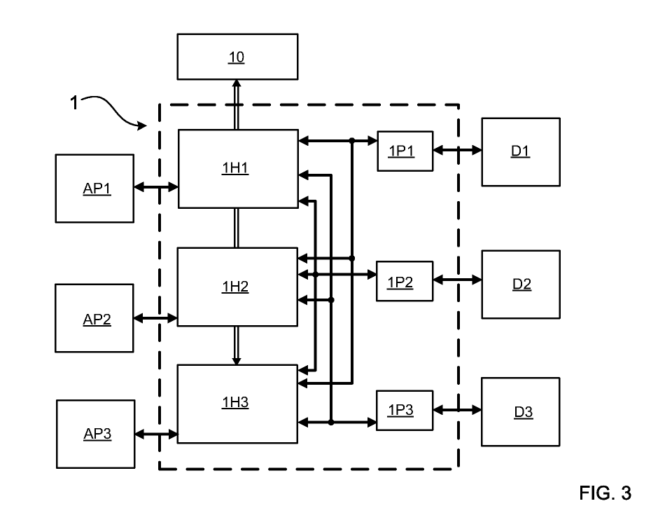

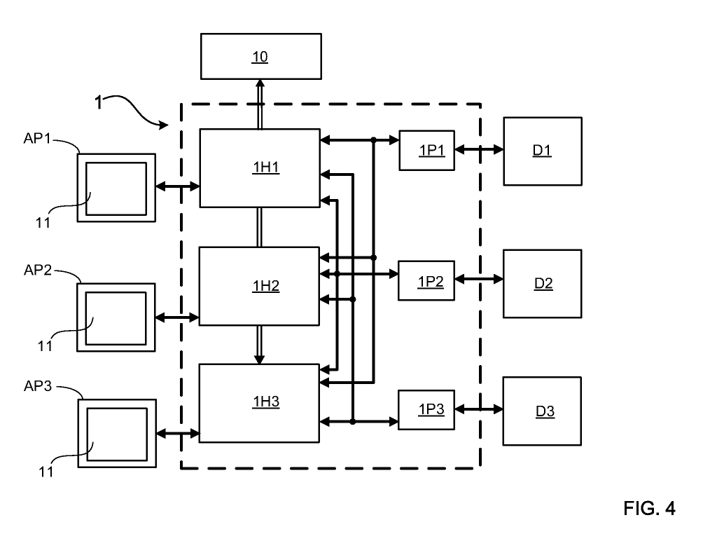

In addition to use the HUB controlling program 11 for controlling the switching of the HUBs, please referring to FIG. 3, which illustrates a second framework view of the sharing device with multi connecting ports for the computer periphery devices according to the present invention, in the second framework of the present invention, a main controlling unit 10 is electrically connected to each of HUBs, so that the switching of each of HUBs may be controlled via the main controlling unit 10. Referring to FIG. 4, which illustrates a third framework view of the sharing device with multi connecting ports for the computer periphery devices according to the present invention, as shown in FIG. 4, when the sharing device 1 of the present invention is implemented, both the main controlling unit 10 and the HUB controlling program 11 can be included into the framework of the sharing device 1 with multi connecting ports. So that, the users are able to switch the HUBs by externally control through the main controlling unit 10, besides, the users also can control the switching of the HUBs via the HUB controlling program 11 installed in the hosts.

When the first HUB 1H1 is controlled to switch on the communication with the first connecting port 1P1, the second HUB 1H2 and the third HUB 1H3 switch off the communications with the first connecting port 1P1, furthermore, when the second HUB 1H2 switches on the communication with the second connecting port 1P2, the first HUB 1H1 and the third HUB 1H3 switch off the communications with the second connecting port 1P2; Meanwhile, the first host AP1 connected to the first HUB 1H1 communicates with the first connecting port 1P1 when the first HUB 1H1 switches on the communication with the first connecting port 1P1, and the second host AP2 connected to the second HUB 1H2 communicates with the second connecting port 1P2 when the second HUB 1H2 switches on the communication with the second connecting port 1P2. Such an ON/OFF design of the connecting ports described above is able to avoid the shut-down of the computer periphery devices when two different hosts simultaneously control the same computer periphery device through the same connecting port. Assuredly, when two connecting ports are switched on by one HUB, the other HUBs will automatically switch off the two connecting ports.

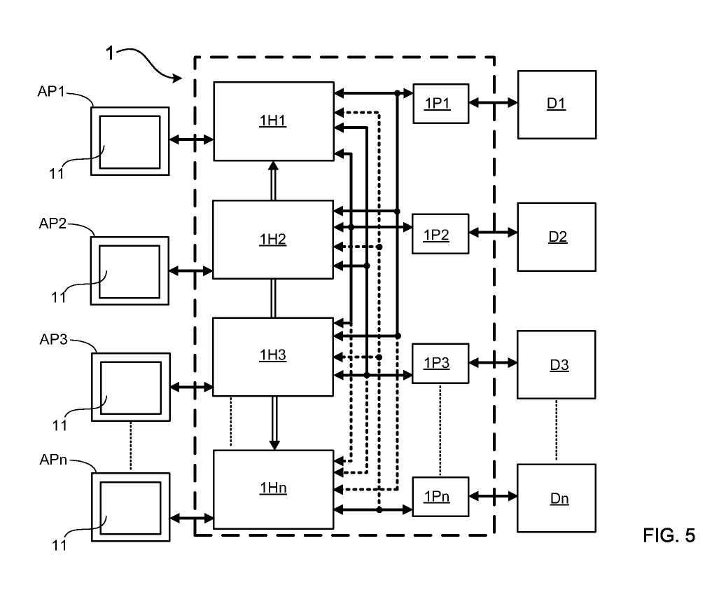

The first, second and third frameworks of the sharing device described above is merely used to connect three hosts and three computer periphery devices. For facilitating the sharing device 1 may connect more hosts and computer periphery devices at the same time, a fourth framework, a fifth framework and a six framework are proposed. Please referring to FIG. 5, which illustrates the fourth framework view of the sharing device with multi connecting ports for the computer periphery devices according to the present invention, as shown in FIG. 5, the sharing device 1 with multi connecting ports for computer periphery devices capable of being connected to a plurality of hosts and a plurality of computer periphery devices, so as to facilitate any one host simultaneously communicate with and control the plurality of computer periphery devices, the sharing device 1 includes: a plurality of HUBs parallel to each other; and a plurality of connecting ports, which are coupled to the plurality of HUBs, respectively, through a single connecting port, a single HUB is connected to a single computer periphery device. Wherein when a first HUB 1H1 is connected to a first computer periphery device D1, the first computer periphery device D1 not only connects to the first HUB 1H1 but also connects to the other HUBs; When a second HUB 1H2 is connected to a second computer periphery device D2, meanwhile, the second computer periphery device D2 connects to the second HUB 1H2 as well as the other HUBs; Moreover, when a N-th HUB 1Hn is connected to a N-th computer periphery device Dn, the N-th computer periphery device Dn connects to neither of the N-th HUB 1Hn and the other HUBs.

Continuously referring to FIG. 5, in the fourth framework of the sharing device 1, the users can switch the HUBs through the HUB controlling program 11 installed in each of the hosts. When the first HUB 1H1 switches on the first connecting port 1P1, meanwhile, from the second HUB 1H2 to the N-th HUB 1Hn, which all switch off the communications with the first connecting port 1P1, moreover, when the second HUB 1H2 switches on the second connecting port 1P2, in the meantime, the first HUB 1H1 and from the third HUB 1H3 to the N-th HUB 1Hn, which all switch off the communications with the second connecting port 1P2; Meanwhile, when the first HUB 1H1 switches on the communication with the first connecting port 1P1, the first host AP1 connected to the first HUB 1H1 communicates with the first connecting port 1P1, and the second host AP2 connected to the second HUB 1H2 communicates with the second connecting port 1P2 when the second HUB 1H2 switches on the communication with the second connecting port 1P2. The same to the first framework of the sharing device 1, in the fourth framework, the ON/OFF design of the connecting ports is able to avoid the shut-down of the computer periphery devices when two different hosts simultaneously control the same computer periphery device through the same connecting port. Assuredly, when two connecting ports are switched on by one HUB, the other HUBs will automatically switch off the two connecting ports.

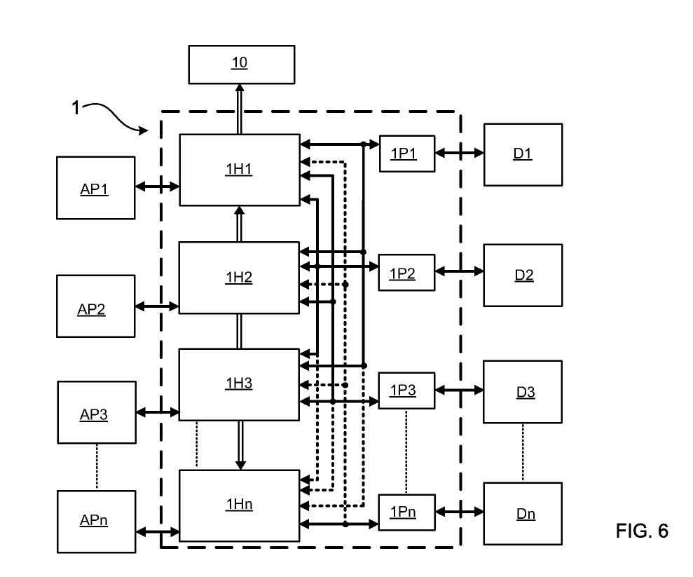

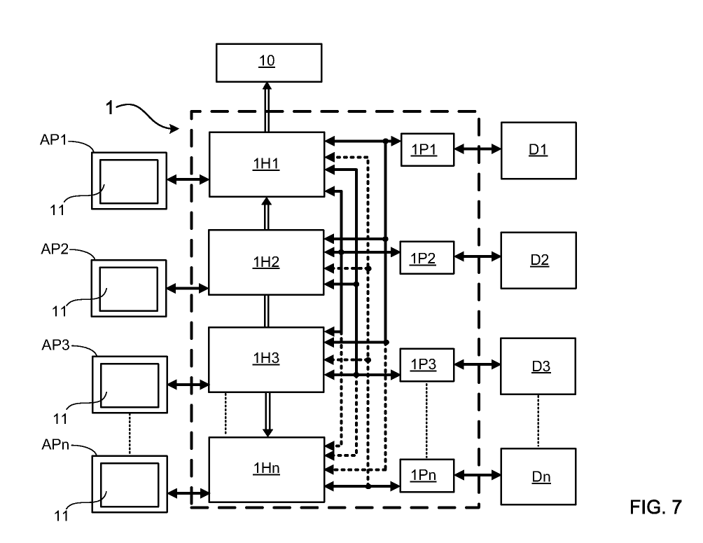

Please referring to FIG. 6, which illustrates the fifth framework view of the sharing device with multi connecting ports for the computer periphery devices according to the present invention, as shown in FIG. 6, the fifth framework of the sharing device 1 includes the main controlling unit 10, the users can switch all of N HUBs by way of external control. Besides, please referring to FIG. 7, which illustrates the sixth framework view of the sharing device with multi connecting ports for the computer periphery devices according to the present invention, in the sixth framework of the sharing device 1, where the main controlling unit 10 and the HUB controlling device 11 are both implemented, so that the users may not only switch the HUBs by externally control through the main controlling unit 10, but also can control the switch of the HUBs via the HUB controlling program 11 installed in the hosts.

Thus, the sharing device with multi connecting ports for the computer periphery devices according to the present invention has been disclosed above completely and clearly through the six kinds of frameworks. In summary, the present invention has the following advantages:
1. Through the sharing device, numbers of hosts can share numbers of computer periphery devices, besides, any one computer may communicate with and control all of the computer periphery devices at the same time without installing any high-price network sharing equipments.
2. When manufacturing the sharing device with multi connecting ports, the HUBs and the connecting ports of the sharing device can be disposed by way of customization, so as to meet the needs of different families and companies.

The above description is made on an embodiment of the present invention. However, this embodiment is not intended to limit scope of the present invention, and all equivalent implementations or alterations within the spirit of the present invention still fall within the scope of the present invention.

I claim:

1. A sharing device 1 with multi connecting ports for computer periphery devices capable of being connected to a first host AP1, a second host AP2 and a third host AP3, and connected to a first computer periphery device D1, a second computer periphery device D2 and a third computer periphery device D3, so as to facilitate the first host AP1, the second host AP2 or the third host AP3 simultaneously communicate with and control the first computer periphery device D1, the second computer periphery device D2 and the third computer periphery device D3, the sharing device 1 comprising:
a first HUB 1H1;
a first connecting port 1P1, being coupled to the first HUB 1H1, through the first connecting port 1P1, the first HUB 1H1 can connect to the first computer periphery device D1;
a second HUB 1H2, being parallel to the first HUB 1H1;
a second connecting port 1P2, being coupled to the second HUB 1H2, by means of the second connecting port 1P2, the second HUB 1H2 may connect to the second computer periphery device D2;
a third HUB 1H3, being parallel to the first HUB 1H1 and the second HUB 1H2; and
a third connecting port 1P3, being coupled to the third HUB 1H3, by way of the third connecting port 1P3, the third HUB 1H3 can connect to the third computer periphery device D3;
wherein the first computer periphery device D1 connects to the second HUB 1H2 and the third HUB 1H3 at the same time when the first HUB 1H1 is connected to the first computer periphery device D1; the second computer periphery device D2 simultaneously connecting to the first HUB 1H1 and the third HUB 1H3 when the second HUB 1H2 is connected to the second computer periphery device D2; moreover, the third computer periphery device D3 connecting to the first HUB 1H1 and the second HUB 1H2 when the third HUB 1H3 is connected to the third computer periphery device D3.

2. The sharing device of claim 1, wherein the second HUB 1H2 and the third HUB 1H3 switch off the communications with the first connecting port 1P1 when the first HUB 1H1 switches on the communication with the first connecting port 1P1; furthermore, the first HUB 1H1 and the third HUB 1H3 switching off the communications with the second connecting port 1P2 when the second HUB 1H2 switches on the communication with the second connecting port 1P2.

3. The sharing device of claim 2, wherein when the first HUB 1H1 switches on the communication with the first connecting port 1P1, the first host AP1 connected to the first HUB 1H1 communicating with the first connecting port 1P1; besides, when the second HUB 1H2 switches on the communication with the second connecting port 1P2, the second host AP2 connected to the second HUB 1H2 communicating with the second connecting port 1P2.

4. The sharing device of claim 1, further comprising an HUB controlling program 11, which can be installed in each of hosts, and then users may control the switch of each HUB when operating hosts through the HUB controlling program 11.

5. The sharing device of claim 1, further comprising a main controlling unit 10, which is electrically connected to each of hosts and capable of switching each host by the external control.

6. A sharing device 1 with multi connecting ports for computer periphery devices capable of being connected to a plurality of hosts and a plurality of computer periphery devices, so as to facilitate any one host communicate with and control the plurality of numbers of the computer periphery devices at the same time, the sharing device 1 comprising:
a plurality of HUBs, being parallel to each other; and
a plurality of connecting ports, being coupled to the plurality of HUBs, respectively, through a single connecting port, a single HUB being connected to a single computer periphery device;
wherein when a first HUB 1H1 is connected to a first computer periphery device D1, the first computer periphery device D1 not only connecting to the first HUB 1H1 but also connecting to the other HUBs; when a second HUB 1H2 is connected to a second computer periphery device D2, meanwhile, the second computer periphery device D2 connecting to the second HUB 1H2 as well as the other HUBs; moreover, when an N-th HUB 1Hn is connected to an N-th computer periphery device Dn, the N-th computer periphery device Dn connecting to neither of the N-th HUB 1Hn and the other HUBs.

7. The sharing device of claim 6, wherein when the first HUB 1H1 switches on a first connecting port 1P1 in said connecting ports, meanwhile, from the second HUB 1H2 to the N-th HUB 1Hn, which all switch off the communications with the first connecting port 1P1; moreover, when the second HUB 1H2 switches on a second connecting port 1P2 in said connecting ports, in the meantime, the first HUB 1H1 and from the third HUB 1H3 to the N-th HUB 1Hn all switch off the communications with the second connecting port 1P2.

8. The sharing device of claim 7, wherein when the first HUB 1H1 switches on the communication with the first connecting port 1P1, the first host AP1 connected to the first HUB 1H1 communicating with the first connecting port 1P1; besides, when the second HUB 1H2 switches on the communication with the second connecting port 1P2, the second host AP2 connected to the second HUB 1H2 communicating with the second connecting port 1P2.

9. The sharing device of claim 6, further comprising an HUB controlling program 11 installed in each of hosts, users may control the switch of each HUB when operating hosts by means of the HUB controlling program 11.

10. The sharing device of claim 6, further comprising a main controlling unit 10, which is electrically connected to each of hosts and capable of switching each host by the external control.
